(19) United States
(12) Patent Application Publication
(10) Pub. No.: US 2006/0251407 A1
(43) Pub. Date: Nov. 9, 2006

(54) Traditional toys for control of media systems

(75) Inventors: Johannes Thordarson, Reykjavik (IS); Helgi G. Sigurdsson, Kopavogur (IS)

Correspondence Address: BIRCH STEWART KOLASCH & BIRCH, PO BOX 747, FALLS CHURCH, VA, 22040-0747, US

(73) Assignee: 3-PLUS hf., Reykjavik (IS)

(21) Appl. No.: 11/340,583

(22) Filed: Jan. 27, 2006

Related U.S. Application Data
(60) Provisional application No. 60/646,980, filed on Jan. 27, 2005.

(30) Foreign Application Priority Data
Jan. 27, 2005 (IS) 7675
Jan. 27, 2005 (IS) 7676

(51) Int. Cl. H04N 5/00

(52) U.S. Cl. 386/126

(57) ABSTRACT

A toy device as well as a system and a method for the use thereof is presented. The toy device is interactive with multimedia systems, such as multimedia computers or DVD players, the control device comprising a plurality of actuators and sensors as well as transmitting means and receiving means. The toy device is characterised by an interactive control member being adapted to operate with said base member and a programming cassette being adapted to operate with said base member.

This Patent Application claims priority from U.S. Provisional Patent Application No. 60/646,980 filed 27 Jan. 2005, as well as Icelandic Priority founding applications Nos. IS 7676 filed 27 Jan. 2005 and IS 7675 filed 27 Jan. 2005.

### AREA OF INVENTION

The present invention relates to an adaptation of traditional toys to remotely control multimedia systems, in particular a DVD player, as well as a system and method thereof. The console is adapted for interactive control of the video system.

### BACKGROUND OF INVENTION

Interactive control of various multimedia computers is presently of increasing interest. Often video players like DVD players offer good quality entertainment. Thus, DVD-video has been synonymous with quality.

A rapid development in the computer game industry has paved the way for new generation of a highly interactive entertainment form. Many computer games display animated material on the screen in response to commands given by the player. The content to be displayed is usually selected from ROM data sources such as optical discs (CD/DVD), solid state device, as well as from downloadable content from the internet and magnetic storage media. Specially designed game stations with cpu means may be used, but other systems use a DVD player, a multimedia computer with disk drives or a computer connected to the internet. The user participates interactively in the game, by means of some control device, by providing responses and inputs to events of the game.

The control devices used for controlling the game and/or to select content from a storage means are either specialized controllers attached to the game device or by means of a remote control unit, keyboard or joystick. WO 2004/109674 discloses a console for playing interactive games using a DVD player, where picture overlays guide the player through the game and the selection of content is based on pressing a picture on the picture overlay having the same appearance as the display on the monitor/TV screen.

### SUMMARY OF INVENTION

The present invention provides a new platform for adapting traditional toys such as cars, trains, playhouses and learning/educational toys to be interactive with different linear video content. The video content can be based on, created or adapted to any kind of toys with implemented sound material, such as instructions or demands. The interactivity can be navigation, direction, questions and answers, educational lessons, etc. Myriad of themes, i.e., education, entertainment, karaoke, memorizing game, decision making game, traffic lessons and languages can be used.

The first object of the invention is to provide an interactive toy for multimedia systems, which is capable of being adapted to different multimedia systems having different sets of remote control signals.

The second object of the invention is to provide an interactive toy that is adapted for use by children from about 2 years old.

The third object of the invention is to provide a gaming platform for the development of multimedia content to match with countless number of interactive toys.

According to the invention, the toy comprises a base member and an interactive control member. The toy further comprises a group of sensors and a group of actuators and a communication means for transmitting and receiving control signals, for example to a multimedia system. Several programs are provided. A programming cartridge is adapted to program the toy to interact with the multimedia device through the means of wireless control signals as well as receiving signals while running in “learning mode”.

### DESCRIPTION OF THE PRESENT INVENTION

According to the first aspect of the present invention the control device interacting with multimedia systems, such as multimedia computers or DVD players, comprises a base member, an interactive control member and a programming cassette. The base member or the body of the control device comprises the following:
at least one group of actuators,
at least one group sensors,
at least one transmitting means,
at least one a receiving means, and
a slot for a programming cassette.

The control device of the present invention is a toy object and preferably a traditional toy object.

Each group of sensors is connected to a corresponding group of actuators. The base unit comprises a first group of actuators being programming keys or buttons, optionally including a programming switch being adapted for programming the toy for interacting with a certain brand of multimedia system, such as a DVD player of a particular brand. The programming keys are 10 representing the numbers from 0-9. The first group of actuators is connected to the first group of sensors. The base member may further comprise a programming switch for setting the toy object in programming mode.

The second group of actuators are individual parts of the base member, such as the wheels of a car, which are connected to the second group of sensors. All the sensors are connected to the transceiving means of the toy. The base member comprises a slot, a plug or a receptacle for receiving a programming cassette and for receiving an additional device member.

The interactive toy device further comprises an interactive control member adapted to operate with said base member and a programming cassette also being adapted to operate with said base member. The base member of the toy object may further comprise a microphone for receiving ultrasound signals from the multimedia system. Furthermore an additional device member may be included for generating a function when plugged into the device. The additional device member may have the function of turning the toy on and off or to initiate interactivity with the multimedia system.

The interactive control member may be replaceable providing additional functions or appearance to the toy. The interactive control member of the toy comprises at least one additional group of actuators and a corresponding additional group of sensors. Additional group of actuators on the interactive control member may be activity switches on a toy being connected to their corresponding group of sensors. The group of sensors on the interactive control member are connected to the transceiving means in the base member of the toy through the slot for the programming cassette in the base member. The interactive control member further comprises a programme selecting actuator for selecting between different programs on a DVD disk.

According to the second aspect of the present invention a system for interactive communication between a toy object and multimedia systems, multimedia computers or DVD players, is provided. The system of the present invention comprises the following:
a toy object, said toy object further comprising:
   a base member, further comprising:
      at least one group of actuators,
      at least one group of sensors,
      at least one transmitting means, and
      at least one a receiving means
      a slot for a programming cassette
   an interactive control member, further comprising:
      a first additional group of actuators,
      a first additional group of sensors,
   a programming cassette,
   a DVD player,
   a monitor, and
   a DVD disk.

The interactive control member is mountable on the toy object and each group of actuators in cooperation with their corresponding group of sensors provide control signals to the DVD player. Furthermore, the programming cassette when mountable on the toy object is adapted to program the communication between DVD player and the toy object. According the system of the present invention the cooperation and the navigation with the DVD-disk comprises automatically selecting a sub-menu or track number or chapter on the DVD-disk by sending a wireless signal such as but not limiting to IR, MW, RF, or ultrasound to the DVD player.

According to the third aspect of the present invention a method is disclosed for operating and interacting with multimedia systems through a toy object. The method comprising the following steps:
placing a DVD-disk in the DVD player,
programming the toy object by placing a programming cassette in the toy object, said toy object comprising:
   a base member, further comprising:
      at least one group of actuators,
      at least one group of sensors,
      at least one transmitting means, and
      at least one a receiving means
      a slot for a programming cassette
   an interactive control member, further comprising:
      a first additional group of actuators,
      a first additional group of sensors,
   a programming cassette,
responding to signals from the DVD player through a monitor or a speaker,
navigating into programs through one or more group of sensors by affecting the one or more group of actuators, and
programming the device with a programming cassette so that the device will interact with the DVD player.

A programming cassette is also provided which is used for programming interactive toy for transmitting and receiving signals to and from said multimedia system through the transmitting means and the receiving means. The programming cassette of the present invention is a programmable non-volatile memory device which can be hosted on, for example but not limited to, a smartcard or some kind of a cartridge.

In an embodiment of the present invention the transmitting means and the receiving means are combined in a transceiving means. According to the present invention in all embodiments disclosed herein, the transmitting means and the receiving means or the transceiving means build on wireless technology, such as but not limiting to, IR, MW, RF, or ultrasound.

The cooperation and the navigation with the DVD-disk comprises automatically selecting content such as a sub-menu, track number or chapter on the DVD-disk by sending a signal to DVD player.

In an embodiment of the present invention the toy object comprises RF (radiofrequency) transceiver. Most common remotely controlled consumer electronics including DVD players are operated via IR remote communication system. IR remote communication systems require an unobstructed line of sight between the transmitter and receiver to operate. To overcome this shortcoming the present invention uses RF communication means and RF/IR converter to interact with the DVD player.

In the present context the term “multimedia system” relates to: A DVD player and TV set with optional home entertainment unit, or a computer with a monitor, speakers, keyboard and a mouse, the computer further comprises: cpu means, storage means and a CD or DVD player.

In the present context the term “transceiver” relates a device that performs, within one chassis, both transmitting and receiving functions that is in a common housing, sometimes designed for portable or mobile use, uses common circuit components for both transmitting and receiving.

In the present context the term “interactive” relates to computer systems requesting and accepting input from a human. The computer systems together with programs allow the user to enter data or commands.

In an embodiment of the present of the present invention the toy device is a play-house, such as a family house, farm, barn or stable, airport etc. The floor of the house would represent the base member, comprising a slot for the programming card and one or more additional slots or sockets for placing additional toy members in such as figures/persons, animals, cars, airplanes etc. Each one of these slots is connected to a sensor for signalling through the transceiver to the DVD player for interactive playing.

In another embodiment of the present of the present invention the toy device represents a flying object such as an airplane or a helicopter. The position within a three-dimensional geofence is detected by a wireless network, and motion detectors and or other sensors detect the posture or the orientation of the flying object.

In an embodiment of the present invention one or more interactive toys are operative directly or through an intermediate console with a DVD player. The intermediate console can be defined as a game operative station comprising the operative components of the interactive toy described above, i.e.
at least one transmitting means,
at least one a receiving means,
cpu means, and
a slot for a programming cassette.

The transmitting and receiving means of the game operative station can be selected from the group of means as discussed above using signals such as rf, IR and ultrasound signals to interact with the DVD player and the speakers of the TV, the multimedia computer or home entertainment unit.

One or more toys are interactive with the DVD player via the game operative station through the transmitting and receiving means of the game operative station, but that interaction can also be through a cable. The interactive toys comprise the following:
at least one group of actuators,
at least one group sensors,
   and optionally:
at least one transmitting means,
at least one a receiving means.

Each group of sensors is connected to a corresponding group of actuators. The first group of actuators, being programming keys or buttons, optionally including a programming switch being adapted for programming the toy for interacting with a certain brand of multimedia system, such as a DVD player of a particular brand. All the sensors are connected to the transmitting and receiving means of the toy. The toy comprises a slot, a plug or a receptacle for receiving a programming cassette and for receiving an additional device member. The toy may further comprise a microphone for receiving ultrasound signals from the multimedia system.

A system for interaction of one or more toys through an intermediate console to communicate with multimedia systems, multimedia computers or DVD players therefore comprises:
one or more toy objects, said toy objects further comprising:
   at least one group of actuators,
   at least one group sensors,
and optionally:
   at least one transmitting means,
   at least one a receiving means,
a programming cassette,
a DVD player,
a monitor, and
a DVD disk.

In one embodiment of the present invention, the toy is the board of a board game. Furthermore, according to the present invention the intermediate console or the game operative station represents the board of the board game and the one or more toys are the players of the board game.

In a specific embodiment of the present of the present invention a programmable toy vehicle to be interactive with multimedia systems is provided. The programmable toy vehicle comprises a chassis on a pair of un-powered front and back wheels, said chassis further comprising:
a truck tractor like housing,
a ten-digit keyboard
a first group of sensors
a second group of sensors
at least on transceiver, and
a slot to receive a programming cartridge.

The programmable toy vehicle further comprises a replaceable interactive control unit, including:
a third group of sensors,
a group of function actuators, and
a programming cassette.

The toy functions with a DVD player, a monitor, and a DVD disk.

The programmable toy vehicle further comprises replaceable interactive control unit to be mounted on the cassis, where a connection to the transceiver is provided through the slot, which is adapted to receive a programming cartridge. The programmable toy vehicle is characterised by a programming cartridge being adapted for programming the programmable toy vehicle control signals to said multimedia systems. The programmable toy vehicle may further comprise a microphone for receiving ultrasound signals from the multimedia system.

The programmable toy vehicle operates with the system and the method of the present invention.

The replaceable interactive control unit is mountable on the control device and each group of actuators in cooperation with their corresponding group of sensors provide control signals to the DVD player. The programming cassette when mountable on the programmable toy vehicle is adapted to program the communication between DVD player and the programmable toy vehicle.

The replaceable interactive control unit is mountable on the cassis and each group of actuators in cooperation with their corresponding group of sensors provide control signals to the DVD player. Furthermore, the programming cassette when mountable on the cassis is adapted to program the communication between DVD player and the toy. According the present invention, the cooperation and the navigation with the DVD-disk comprises automatically selecting a sub-menu or track number or chapter on the DVD-disk by sending an IR or an RF signal to the DVD player.

The following embodiments relate to the product, the system and the method of the present invention.

In an embodiment of the present invention the first group of actuators is connected the first group of sensors, the second group of actuators is connected the second group of sensors and the third group of actuators is connected the third group of sensors. The cassis comprises a first group of actuators being programming keys or buttons, optionally including a programming switch being adapted for programming the toy for interacting with a certain brand of multimedia system, such as a DVD player of a particular brand. The second group of actuators are individual parts of the cassis, such as the wheels of a car, which are connected to the second group of sensors. The second group of sensors may also comprise motion detectors. All sensors are connected to the transmitting means and the receiving means of the toy device. The cassis comprises one slot for receiving a programming cartridge and another slot for receiving an additional toy member. The additional toy member is according to an embodiment of the present invention a truck driver adapted to be inserted into said truck tractor like housing to switch on the programmable toy vehicle and/or to initiate the interactivity.

The replaceable interactive control unit provides multifunctional vehicles, whereby replacing the replaceable interactive control unit alters the appearance to the toy vehicle. The replaceable interactive control unit comprises a third group of sensors and a group of function actuators, but these function actuators are characteristic for the nature of the vehicle, i.e. hose, ladder and a fire extinguisher on a fire truck. The third group of sensors on the replaceable interactive control unit are connected to the transmitting means and the receiving means through the slot for the programming cassette. The replaceable interactive control unit further comprises a programme selecting actuator for selecting between different programs on a DVD disk. The person playing with the toy vehicle generates signals by affecting the group of function actuators, which are detected by the third group of sensors and thereafter delivered to the transmitting means through the slot for the programming cassette. Signals are further delivered to the DVD player through a transceiver, which ultimately results in a selection of content, within a program, on the DVD disk. A selection between different programs on the DVD disk can be made by the programme selection actuator on the replaceable interactive control unit. The programming cassette of the present invention is a cartridge containing codes for a large number of DVD players. The programming cartridge is updateable.

In an embodiment of the present invention the DVD disk can send out an ultrasound signal upon a certain signal from the person playing the game. The control device can detect ultrasound signals from the DVD disk by a microphone in the cassis or the replaceable interactive control unit resulting in an action from the toy vehicle. Such a response can be the onset or turning off a siren.

The truck tractor like housing can opens about a pivot pin. A slot inside the housing is adapted to be a switch for turning on the device or starting interactivity with the DVD player. By placing a toy driver in a slot in the truck tractor like housing, the interactive toy vehicle is switched on and/or interactivity is initiated.

The wheels of the cassis are actuators and four sensors detect a forward and a backwards movement of the wheels as well as a left turn or a right turn of the wheels. Wheels are actuators

In an embodiment of the present invention the programmable toy vehicle comprises an infrared (IR) transceiver. It could be an advantage to use radio frequency (RF) control signals since IR signals generally require line-of-sight travel between the sending device and the receiving device. With respect to the nature of the sending device (the programmable toy vehicle) it is possible that there will not be a line-of-sight between the sending device and the receiving device at all times, hence RF signals may be required. In case of using RF signals a RF/IR converter is applied to receive RF signals from programmable toy vehicle and forwarding the signals as IR signals to DVD player.

The embodiments listed above relate to the product, the system and the method of the present invention.

The present invention provides a new platform for using different linear video content, adapted and developed further for interactive use. The video content can be based, created or adapted from any kind of video and\or sound material, animated or not, accompanied by a sound track or not. The interactivity can be navigation, direction, questions and answers, educational lessons, etc. Certain themes, i.e., education, entertainment, board games, karaoke, memorizing game, decision making game, traffic lessons, and languages can be used.

The embodiments listed above relate to the product, the system and the method of the present invention.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Other objects, features and advantages of the invention will appear from the following detailed description of embodiments of the invention with reference to the appended drawings, which are given by way of illustration only, and thus are not limitative of the present invention, and in which:

FIG. 1 is a schematic view of the components of the interactive toy object.

FIG. 2 discloses the components of the system of the invention

FIG. 3 discloses the toy vehicle components for one selected embodiment.

FIG. 4 discloses the vehicle body.

FIG. 5 a) discloses how the activation and the programming components of the toy vehicle and b) discloses the relationship between the programming card and the replaceable interactive control unit.

FIG. 6 is a schematic drawing of a selected embodiment, disclosing the function actuators.

### DETAILED DESCRIPTION OF EMBODIMENTS

The operation of the device will appear from the details of operation of an embodiment given below. The details are given in order to make a skilled person able to perform the invention, but do not limit the invention.

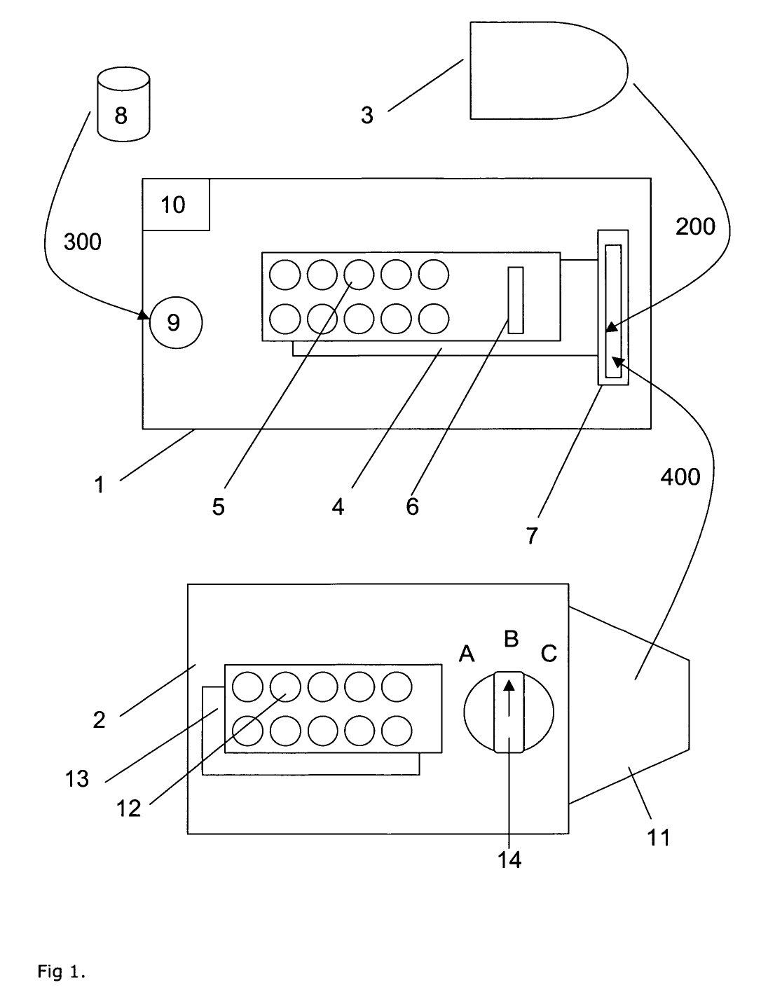

The main components of the toy object are disclosed in FIG. 1, a base member 1, interactive control member 2 and a programming card 3. The base member 1 includes a group of sensors 4 connected to a group of actuators 5. In this embodiment the first group of actuators 5 represents the numbers from 0-9, i.e. 10 actuators. The base member 1 may further comprise a programming switch 6, for operating in the programming mode, and a slot 7 for inserting the programming card 3. Optionally an additional piece 8 is placed into a second slot 9 on the base member 1 to switch the device on and off or for operating in the programming mode. The sensors and the slots of the device are connected to the transceiving means 10. When the toy object is programmed to interact with a certain brand of multimedia system, such as a DVD player of a certain brand, the programming card 3 is inserted into the slot for the programming card 7 and either the programming switch is turned on or the additional piece 8 is inserted into the second slot 9 to turn on interactivity. When the toy object is in programming mode, the DVD code for the specific DVD player can be keyed in using the actuators 5. The programming card 3 is then removed and the interactive control member 2 is attached to the base member 1. A plug 11 adapted to the interactive control member 2 is inserted into the slot for the programming card 3. The interactive control member 2 comprises a first additional group of actuators 12 and a first additional group of sensors 13 as well as a programming selector 14, which can select between different content, such as different programs for the same device in a database. Such a database is in this embodiment is stored on a DVD disk, but can be stored on any media, such as solid state memory chip, the internet, etc. The additional group of actuators 12 are connected to the additional group of sensors 13, which are connected to the transceiving means 10 together with the programming selector 14 through slot 7 on the base member 1.

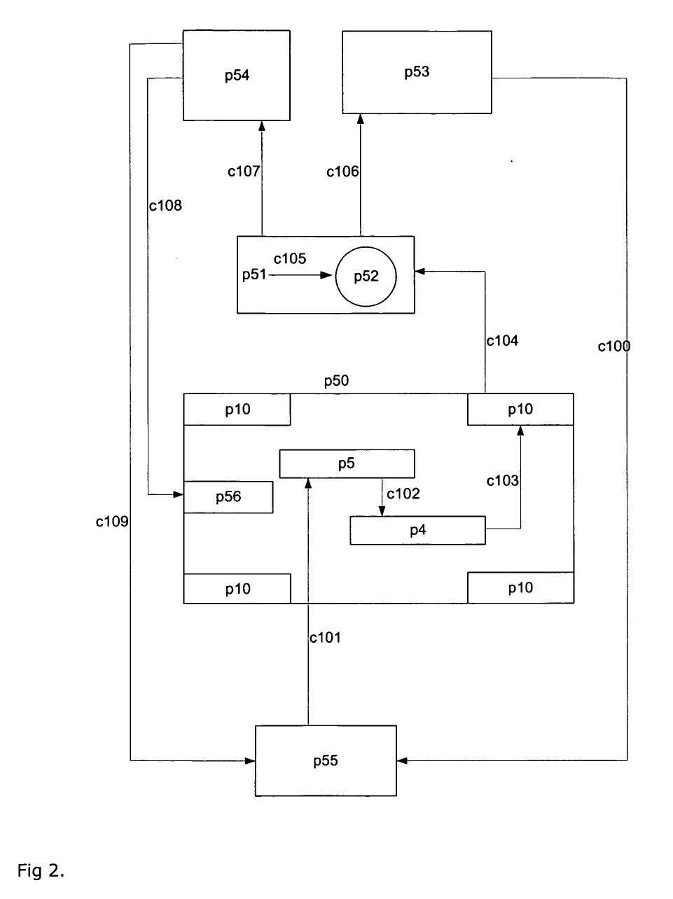

FIG. 2. shows both the different parts, denoted by the prefix “p”, and the commands denoted by the prefix “c”. The components of the system and the method of the present invention in an embodiment where the multimedia system is a DVD player in a home entertainment centre. The system comprises an interactive toy object p50, a DVD player p51, DVD disk p52, monitor p53, speakers p54, and a person p55 playing with the system. The toy object p50 comprises the components disclosed in FIG. 1 as well as a microphone p56, for detecting ultrasound generated by the DVD disk p53.

Once the game is initiated by inserting a DVD disk p52 into the DVD player p51, an image is presented c100 on the monitor p53 with an optional sound message, presenting the game and giving the first command or instruction on what to do next. The person responds c101 by pressing actuators on the toy object p50, which results in contact c102 with the sensors forwarding a signal c103 to a transceiver p10. The transceiver p10 transmits c105 a signal to the DVD player and specific content is selected c106 on the DVD disk. Based on the selection of content a new image is displayed c107 on the monitor or a sound generated c107 form the speakers. If the sound signal is an ultrasound signal generated c108 for triggering a mechanical action within the toy object p50, the ultrasound signal is detected by a microphone p56 in the toy object p50. If the sound signal is a voice or a sound command c109 intended for the person, it is delivered through the speakers in the TV or through speakers in a multimedia computer or a home entertainment unit. An image is observed c100 through the monitor/TV by the person and the sequence of a single action is completed and another command or instruction has been given.

The programming of the device is based on the Universal Infra-Red Remote Control technology. The device is programmed by inserting the provided “Programming cassette” in the device and entering codes in this program mode. These codes are determined according to the brand and type of the user's DVD player corresponding to a Brand Setup Code list.

If no code is available for the user's DVD player type, the bi-directional Step-N-Set feature is available. As a last resort, the device is also able to learn each necessary IR-codes from the original DVD remote control.

This device is designed for children from 2 year old to interact with standalone DVD players with DVD-discs especially formatted to fit with the corresponding device. By selecting different program using the programme selecting actuator on the interactive control member different programs on a DVD disk may be selected. The TV screen appearance changes according to the related content of the disc.

Navigation in the programs is done by operating the actuators on the device, which results in a selection of a sub-menu or track number or chapter on the disk by sending an IR signal to the DVD player. The device is activated to interact with the DVD player by some function such as placing an additional toy member in a slot in the base member of the device. All actuators are disabled when the device is not activated. As the device is activated to interact with a DVD player, the selection or navigation in each sub-menu is done by pressing, pulling, turning etc. the actuators. A display on the monitor or a voice message from the multimedia system gives instructions regarding which actuator should be operated each time. By this action, the user contacts a sensor in the device and the corresponding chapter, title or track selected.

When the programming is initiated by turning on the programming switch on the base member of the device, the remote control unit emits one beep and the chip is set to “programming mode”, waiting for the user's next action. The numerical keyboard on the base member of the device is used for operating in the programming mode, where the digit “1” represents play and the digit “0” represents pause.

Normal Programming Mode:
1) Switch on to programming mode. Device emits one strong beep. The chip is ready for programming.
2) Look up the brand name and type of the DVD player you want to interact with in the user's manual code list.
3) Enter the three-digit code for the corresponding device.
4) Device recognizes and memorizes the code and emits 2 strong beeps.
5) Switch off the programming mode. Chip exits the programming mode and device emits 1 strong beep.

Auto-search Programming Mode:
1) Turn on the DVD player. Switch on to programming mode. Device emits one strong beep. The chip is ready for programming.
2) Aim the device at the DVD player and press “1” once. The device starts browsing its entire signal library by sending sequentially an On/Off signal. To make the user sure that the device is operating, it emits one low beep with every signal.
3) When the DVD player turns off, the user presses immediately “1” again. Device recognizes and memorizes the code and emits 2 strong beeps.
4) Switch off the programming mode and device emits 1 strong beep.
5) If no codes have been found and the entire library has been browsed, device emits 3 strong beeps and stops sending signals.

Learning Programming Mode:
1) Put the device on a flat surface along with the DVD player's remote control. The remote control must be aimed at the IR receiver on the lower part of the control unit device
2) Switch on to programming mode using the programming switch on the base member. Device emits one strong beep. The chip is ready for programming.
3) Press the “1” key on the digital keyboard (“play” in normal mode). Device emits 1 strong beep and chip is ready to memorize the signals from the IR receptor.
4) Press the “TOP MENU” button on the remote control (a.k.a. “DVD MENU”, “TITLE MENU”, “ROOT MENU” etc.). DVD-kids device emits one low beep and stores the signal.
5) Press successively first on the “1” key on the digital keyboard, and then 2, 3, 4, 5, 6, 7, 8, 9, and then on the remote control the buttons 1, 2, 3, 4, 5, 6, 7, 8, 9, 0. Device emits 1 low beep each time a signal is identified and stored.
6) After the 1 has been pressed and the device has stored all signals, it emits 2 strong beeps.
7) Switch off the programming mode. Chip exits the programming mode and device emits 1 strong beep.

Other programming features may be used, as described below.

The activity board may have the following features:
11 physical activities (and possibly 1 hidden activity) on the base member:
   Universal DVD, worldwide load
Learning (custom)
Direct set (custom)
Bi-directional Step-N-Set (custom)
Blink Out (custom, audible feedback)
Stuck Activity time-out
Code Verification (custom)
1 beeper for audible feedback
24K microprocessor—Samsung S3P/C80F9XLP-SOB7 (SOP-32pin)
3 IR LEDs
1K EEPROM
4 AA-6-volt product

The device has 4 modes in the way of sending signal to the DVD player:
Mode 1. sends “ENTER” after each numeric signal
Mode 2 sends numeric signal alone.
Mode 3 sends “0” in front of numeric signal.
Mode 4 sends “0” in front of numeric signal and “ENTER”

Default mode is Mode 1.

The actuators may have the following features:
“0”: This activity transmits the Play function in normal operation mode. For ID's that have a combined Play/Pause activity, the “0” is used for the Play/Pause toggle function. When starting a new game this actuator may function as an internal digit 0 during direct set & ID code verification (Not IR digit 0). This actuator can also be used to start the “learning” programming mode.
“1”: This activity transmits the Pause function in normal operation mode. This actuator can also be used to start the “auto-search” programming mode.
Other actuators: These activities function as regular digit activities in every mode. The described embodiment may have one or several of the following features:

Audible feedback (beep): Audible feedback is used for user feedback and for confirmation of programming sequences.

Short Beep: Time duration for the short beep is 150 msec. Short beep signals a valid activity movement. Multiple short beeps convey information to the user or signal a programming sequence. Delay between short beeps will be 200 msec.

Long Beep: Time duration for the long beep is 600 msec. Long beeps signify invalid activity sequence or bad or no EEPROM installed.

Boot up Beep: The device will generate 2 short beeps when batteries are applied to a previously uncharged device. No EEPROM or bad EEPROM will generate two short beeps and one long beep.

Time-Out: If 20 seconds has elapsed after an actuator movement, the remote will exit the programming state or current state.

Stuck Activity Time-Out: After any actuator is pressed continuously for 20 seconds, the remote will stop signal transmission to conserve battery life.

Simultaneous Activity Movement: If more than one actuator is pressed simultaneously, signal transmission will stop until all the activities are released, and then the remote will go into Stop Mode.

Stop Mode: This is the idle state of the micro-controller when it draws the least amount of current. This is entered by executing the Stop command in the internal firmware.

Unassigned Activities: The remote control shall ignore any unassigned actuator movement for a particular mode and not transmit IR unless otherwise noted.

ID—Number of Digits: Each ID code or set up code consists of four digits from 0 to 9 and is defined in the main UEI database.

Power Up with Default Device Mode and Codes: The standard control unit operation at initial power up shall default to the DVD mode. Other modes can be Set-Top-Box mode, PC mode or similar for the different devices it is meant to operate. The unit shall generate 2 short beeps at initial power up.

Normal Operation: During normal operation the control unit shall generate a short beep with every activity pressed, unless otherwise stated.

Bi-directional Step-N-Set “Advance Search”:
DVD player must be manually switched on and a DVD must have been inserted.
Activity board must be set into programming mode by switching on the programming switch on the base member, indicated by 2 short beeps
Press and hold the “1” key for 2 seconds. The device will generate 2 short beeps to confirm the Bi-directional Step-N-Set mode
Press the “1” key to step through the ID's one by one, transmitting the Play command with each movement, starting with the most popular code and works it's way down to the least popular code. The activity board shall generate 1 short beep with pressing each actuators to confirm each code transmitted. Once the correct ID has been selected, the DVD Player should start playing the DVD.
Press and hold the “0” key for 2 seconds to store the selected ID in EEPROM. The activity board will generate 2 short beeps to confirm successful programming.
If the user accidentally pressed the “1” key too quickly and passed onto the next ID with the DVD player starting to play on the previous ID, the user can press the “0” key (less then 2 second) to scroll backwards through the ID's one by one (The DVD player should pause).
The bi-directional Step-N-Set function has an end of cycle designator (indicated by 3 short beeps) to indicate when a cycle has been completed. The unit shall begin to cycle through the available codes again, starting with the most popular code.

The activity board automatically exits the programming mode, returns to the idle mode, generates a long beep and restores the last pre-programmed code under two conditions:
when any activity other than the “1” or “0” is pressed
when no activity is pressed within 20 seconds

To terminate the programming sequence the toy object may be turned off at any time. One long beep shall be emitted to indicate an unsuccessful programming sequence.

ID Code Verification (990): The device ID code for a mode shall be verified as follows:

Switch on to programming mode→9→9→0→1(count beeps)→2(count beeps)→3(count beeps)→4(count beeps)

Toy object must be successfully turned on and switched on to programming mode, indicated by 2 short beeps. The number of beeps counted after pressing each digit 1, 2, 3, and 4 key shall represent the 4-digit device ID code for the selected mode beginning with the left most digits. The delayed start of the beeps shall be 0.5 seconds with a 0.5 second delay after each key press for digit 1, 2, 3 and 4. The remote shall exit the ID Code Verification state when, after performing the sequence 9→9→0, the user presses any key other than digit 1. If the sequence of pressing digits 1, 2, 3, and 4 for counting blinks is not maintained, the remote shall exit the ID Code Verification state. Operation error and state exit shall be marked by the alarm generating a long beep. The console shall time out after 10 seconds during programming.

To terminate the programming sequence the programming switch may be turned off at any time. One long beep shall be emitted to indicate an unsuccessful programming sequence.

Low Voltage Detection: Low voltage detection is controlled by hardware (Samsung™ chip). The low voltage condition is recognized by software as an external reset. The console shall generate 4 short beeps and not transmit signal when the low voltage condition is initially reached. While in the low voltage condition, the unit will not operate.

Memory Retention—Long Term: The programmed target device codes shall be saved in EEPROM upon power outage or battery removal. The device codes and learned data shall be permanently retained; all units are equipped with EEPROM.

Simultaneous Double Activity Movement—Standard Action: Upon detection of a simultaneous double activity movement, the unit will stop transmitting signals until all activities are still. After all activities are still, signal will be sent upon a movement of a single actuator as per standard operation.

Stuck Key Time Out: The remote shall stop transmitting signal and conserve power upon any activity being moved longer than 20 seconds.

High Frequency signal: Primarily for the European marketplace, Samsung™ micro controllers are capable of operating up to 450 KHz carrier frequencies.

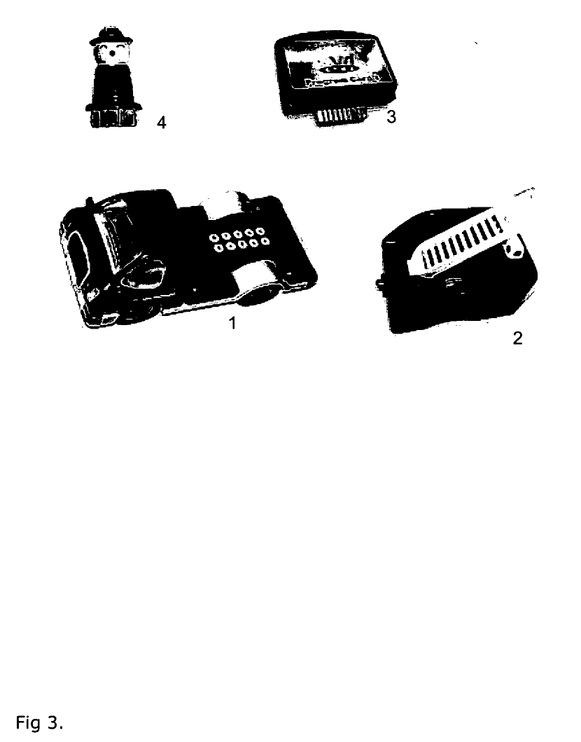

FIGS. 3-6 show a specific embodiment of the present invention, wherein a fire-truck toy vehicle is disclosed. FIG. 3 discloses the components of the interactive fire-truck toy vehicle comprising a vehicle body 31, a replaceable interactive control unit 32, programming card 33 and a driver 34 having an on/off switch function. The program cartridge is provided for programming the toy vehicle to communicate with all brands of DVD players.

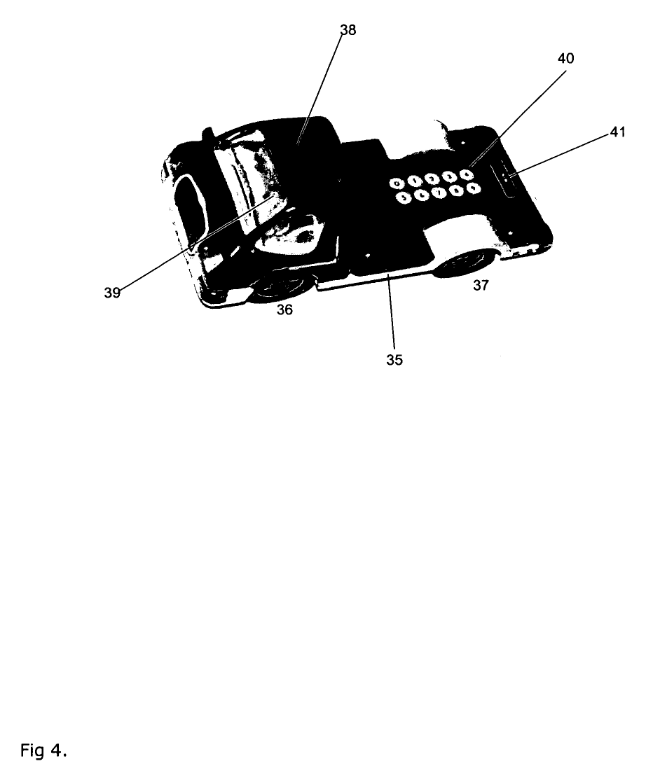

The body of the vehicle is disclosed in FIG. 4. The vehicle comprises a chassis 35 on a pair of un-powered front 36 and back 37 wheels on axles for free rotation. The chassis 35 comprises a truck tractor-like housing 38 mounted on the front end of the chassis. The truck tractor-like housing 38 comprises plastic window shields, where the roof and the hood can be lifted/tilted about a pivot pin on the backside of the roof or on just above the front fender for placing the driver 34 into the driver seat 39. The driver seat is a socket 39 for plugging in the driver 34, which has an on/of function. The flat aft end of the vehicle chassis 35 comprises a ten-digit keyboard 40 and a slot 41 for receiving the programming cartridge 33. The ten-digit keyboard 40 (buttons) are connected to a first set of sensors for programming the activity board to communicate with a DVD player of a certain model through a transceiver 10. The sensors may be mechanical or magnetic contacts.

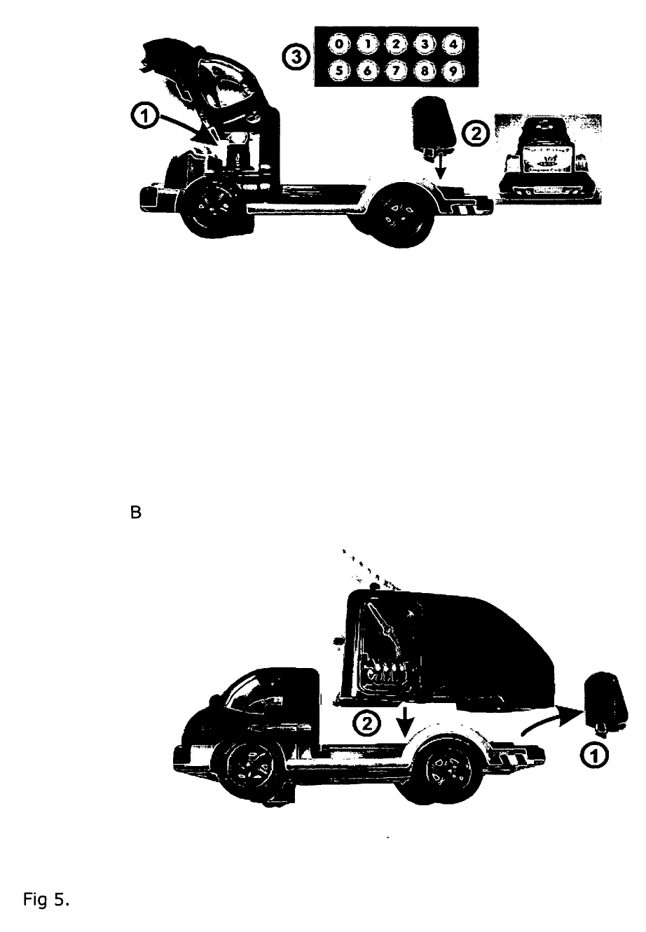

In FIG. 5a, the programming of the vehicle is outlined. The action steps are indicated with circled numbers. The toy vehicle is programmed to interact with a certain brand of multimedia system, such as a DVD player of a certain brand, by inserting the driver into the driver seat (socket) 9 to turn on interactivity and the toy is in programming mode (1). The programming card is next inserted into the slot for the programming card (2). When the toy vehicle is in programming mode, the DVD code for the specific DVD player can be keyed in using the 0-9 digits. FIG. 3b shows how the programming card is removed (1) and replaceable interactive control unit is attached to the cassis (2). A plug is adapted to the replaceable interactive control unit in order for it to be inserted into the slot for the programming card.

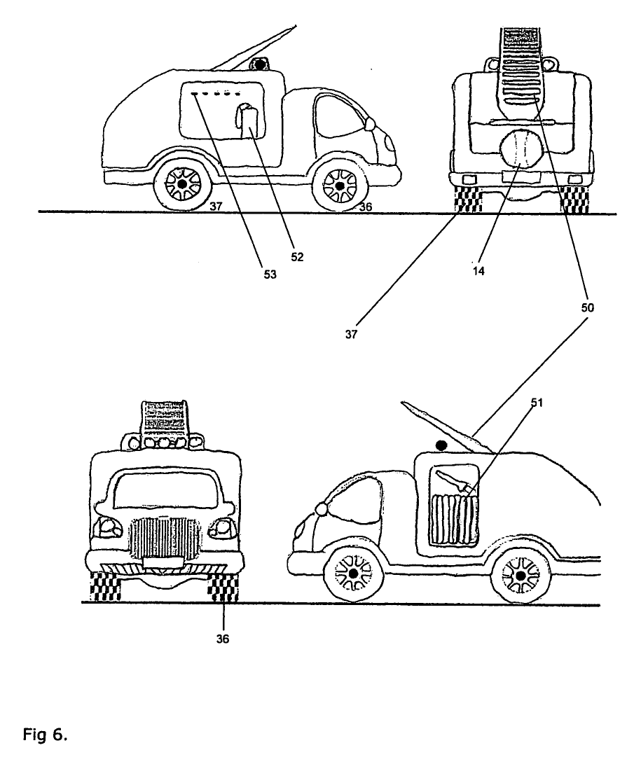

FIG. 6 discloses the actuators on the toy vehicle fire truck. The components of such a fire truck are outlined as each component is a function actuator generating a signal when used during a game. The following function actuators generate signals in this particular embodiment:
1) a ladder 50 on top of the truck can be pulled up and turned (two different signals).
2) a hose 51 can be pulled out (1 one signal)
3) fire extinguisher 52 can be pulled out (1 one signal)
4) a pump panel 53 (turning knob) generates one signal.
5) Forward movement of wheels 36 and 37 (1 one signal)
6) Backwards movement of wheels 36 and 37 (1 one signal)
7) Right turn of wheels 36 and 37 (1 one signal)
8) Left turn of wheels 36 and 37 (1 one signal)

The programming selector 14 can select between different content, such as different programs for the same device in a database. Such a database is in this embodiment a DVD disk, but can be any database, such hardware, the internet or any other storing means. The function actuators are connected to an additional group of sensors, to the transceiver 10 together with the programming selector 14 through the slot on the cassis.

According to a normal living room range for IR communication suggests the use of 4 sets transmitter on the truck's corners.

This programmable toy vehicle is designed for children from 2 year old to operate standalone DVD players with DVD-discs especially formatted to fit with the vehicle. By affecting the various group of actuators, the TV screen appearance changes according to the related content of the disc.

The programmable toy vehicle can also be used as a communication station with DVD players, Set-Top-Boxes for TV and computer.

### EXAMPLES

### Example 1

### An Interactive Ambulance Toy Truck

The playing is initiated as the player inserts a disc in the DVD player. When the disc is inserted in the DVD player, the player automatically plays the standard dvd-toys intro clip.

The game then goes to the normal operating mode, displays the MAIN MENU and waits for initiation of the game.

After playing the intro clip or if no activity is detected for a certain period of time at any point on the disc, the player must go back to the MAIN MENU. The toy object sends the MAIN MENU signal to the player (also called TITLE MENU or even DVD MENU on some remote controls). To avoid automatic playback of the last sequence played as it occurs on most DVD players, authoring of the disc must discard the resume playing function.

The MAIN MENU is a lightly animated screen that could be compared to the Title Menu or Top Menu of a regular DVD. In the present example, three choices are possible on the screen (buttons or scrolling menu), a) a patient pick-up from a car accident, b) a patient pick-up from a home and c) a patient pick-up from a fire. The selection is made by turning the programme selection knob on the back of the interactive control member on the truck. The game is initiated when the first activity is activated by pushing the truck forward resulting in a signal being sent to the player. The operation is similar to pressing a number on a regular DVD remote control to directly select an item in a multiple entry menu.

Each activity represents a sequence on the disk. This means that for example the rear door of the truck is opened an animation sequence opening an ambulance door on the screen or an movie sequence showing the same. When a sequence is selected on the toy object, it is always possible to select another sequence without waiting for the MAIN Menu to come back on the screen. This is obtained by the Random/Shuffle feature.

In the opening the rear door activity and pulling out the stretcher from the truck, the shuffle feature is preferably used over the random feature. This ensures that the same sequence will not be played several times (or under different activity) during the game. This is further explained here below:

Random: DVD player is told to pick and play one of the sequence in the defined group. Unfortunately later in the game, the same sequence is possibly picked and played again under the same or another button.

Shuffle: DVD player is told to pick and play one of the sequences in the defined group and then “remembers” that this sequence has been played already. The same sequence cannot be shown twice during the same session. When all activities have been carried out, this feature should then be “cleared” to make possible another game if the same activity is activated again.

Sound Effects.

There is a sound loop in the Activity Menus and the MAIN MENU. As it has not been mixed while creating the animated Activity Menus, the music loop is added before final authoring. An ultra sound signal may be inserted on the DVD disk, and when used a signal needs to transmitted to the toy object. A microphone is placed in the base member of the toy object for receiving the sound signal from the DVD disk. This may be implemented for initiating the siren on the ambulance as it is requested to pick up a patient and may be terminated by a second ultrasound signal as the ambulance arrives at the scene of accident.

Moving an actuator on the toy object has the same effect as pressing buttons on a regular DVD player's remote controller.

TABLE 1
ambulance

| Activity | Monitor view | Sound signal |
|---|---|---|
| Wheels moving | Truck drives | siren |
| forward | forward | |
| Wheels moving | Truck drives | siren |
| backwards | backwards | |
| Wheels tuning | Truck takes a | siren & |
| left | left turn | Screeching |
| Wheels tuning | Truck takes a | Siren & |
| right | right turn | Screeching |
| Opening rear | Paramedics step | Sound of a |
| doors | out of the truck | door opening |
| Pulling out | Paramedics pull | People talking |
| stretchers | out stretchers | |
| Pulling out the | doctor grabs | People talking |
| doctors bag | the doctors bag | |
| Placing the | Toy object | Theme song |
| driver in the | becomes | |
| driver seat | interactive | |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

Hereinabove has been described an embodiment and several features thereof. It is realized that the features may be combined in different manners than those described and such combinations should be included within the scope of the invention. The invention is only limited by the appended patent claims.

1. A control device to be interactive with multimedia systems, such as multimedia computers or DVD players, the control device comprising
a base member, further comprising
at least one group of actuators,
at least one group of sensors,
at least one transmitting means, and
at least one a receiving means
a slot for a programming cassette
characterised by an interactive control member being adapted to operate with said base member and a programming cassette being adapted to operate with said base member.

2. A control device according to claim 1, wherein at least one group of actuators is connected to at least one group of sensors.

3. A control device according to claims 1 or 2, wherein the transmitting means and the receiving means are combined in a transceiving means.

4. A control device according to claim 1, wherein the transceiving means is an IR transceiver.

5. A control device according to claim 1, wherein the transceiving means is an RF transceiver.

6. A control device according to claim 1, wherein the cassette is a non-volatile memory device, hosted on a cartridge, smartcard or any other suitable package.

7. A control device according to claim 1, wherein the interactive control member further comprises a first additional group of actuators and a first additional group of sensors, wherein the first additional group of actuators are connected to the first additional group of sensors.

8. A control device according to claim 1, wherein the first additional group of sensors are connected to the transmitting means and the receiving means through the slot for the programming cassette.

9. A control device according to claim 1, wherein the interactive control member further comprises a programmer selecting actuator.

10. A control device according to claim 1, wherein a first group of actuators are adapted for programming the device for interacting with a certain brand of multimedia system.

11. A control device according to claim 1, wherein the base member further comprises a microphone.

12. A control device according to claim 1, wherein the programming cassette is adapted for programming said control device for emitting and receiving signals to and from said multimedia system through the transmitting means and the receiving means.

13. A control device according to claim 1, wherein the base member further comprises a programming switch for setting the control device in programming mode and/or to initiate the interactivity.

14. A system for interactive communication between a control device and multimedia systems, such as multimedia computers or DVD players, the system comprising:
a control device, said control device further comprising:
a base member, further comprising:
at least one group of actuators,
at least one group of sensors,
at least one transmitting means, and
at least one a receiving means
a slot for a programming cassette
an interactive control member, further comprising:
a first additional group of actuators,
a first additional group of sensors,
a programming cassette,
a DVD player
a monitor
a DVD disk, and
wherein the interactive control member is mountable on the control device and each group of actuators in cooperation with their corresponding group of sensors provide control signals to the DVD player, and
wherein the programming cassette when mountable on the control device is adapted to program the communication between DVD player and the control device.

15. A system according to claim 14, wherein additional toy members are included to be attached to said toy device to switch on the control device and/or to initiate the interactivity.

16. A method for operating and interacting with multimedia systems through a control device, the method comprising:
placing a DVD-disk in the DVD player,
programming the control device by placing a programming cassette in the control device, said control device comprising:
a base member, further comprising:
at least one group of actuators,
at least one group of sensors,
at least one transmitting means, and
at least one a receiving means
a slot for a programming cassette
an interactive control member, further comprising:
a first additional group of actuators,
a first additional group of sensors,
a programming cassette,
responding to signals from the DVD player through a monitor or a speaker,
navigating into programs through one or more group of sensors by affecting the one or more group of actuators, and
programming the device with a programming card so that the device will interact with the DVD player.
wherein the cooperation and the navigation with the DVD-disk comprises automatically selecting content such as a sub-menu, track number or chapter on the DVD-disk by sending a signal to DVD player.

17. A method according to claim 16, wherein a selection between different programs on the DVD disk can be selected by programmer selection actuator on the interactive control member.

18. A method according to claim 16 or 17, wherein control device can detect ultrasound signals from the DVD disk by a microphone in the base member.

19. A method according to claim 16, wherein an additional toy member is attached to said toy device to switch on the control device and/or to initiate the interactivity.
